(19) United States
(12) Patent Application Publication
(10) Pub. No.: US 2024/0139835 A1
(43) Pub. Date: May 2, 2024

(54) CUTTING TOOL AND TOOL BODY THEREOF

(71) Applicant: TUNGALOY CORPORATION, Fukushima (JP)

(72) Inventor: Hikaru SHIROMA, Iwaki-shi (JP)

(73) Assignee: TUNGALOY CORPORATION, Fukushima (JP)

(21) Appl. No.: 18/497,550

(22) Filed: Oct. 30, 2023

(30) Foreign Application Priority Data
Oct. 31, 2022 (JP) 2022-174319

(51) Int. Cl. B23C 5/10

(52) U.S. Cl. CPC B23C 5/109; B23C 2200/0472

(57) ABSTRACT

The present disclosure can realize further prevention of a mounting mistake caused when a cutting insert is mounted on an insert seat is implemented by voluntarily improving a structure around the insert seat in particular. An insert mounting part has a shape including a bottom surface, a constraint surface that comes into contact with at least a part of a constraint target surface formed as a surface of a peripheral side surface of the cutting insert inclining with respect to an upper surface or a lower surface, an evacuation part that allows evacuation from the constraint surface hedging a cutting edge of the cutting insert, a first protrusion area that extends hiding a part of the upper surface or the lower surface of the cutting insert, a relief part that is formed at a part that a corner part of the cutting insert approaches so as to hedge the corner part, and a second protrusion area that extends from an upper side of the relief part so as to cover the part of the upper surface or the lower surface of the cutting insert mounted on the insert mounting part.

### BACKGROUND

### Field

The present disclosure relates to a cutting tool and a tool body thereof.

### Description of Related Art

As a cutting tool for milling such as an endmill, a cutting tool that includes one set of two cutting inserts is used. One of the one set of these cutting inserts is referred to as a center edge insert, and includes a center cutting edge (also referred to as a front surface cutting edge) that extends from a peripheral surface to a rotational center of a tool body, and a short peripheral cutting edge that is located on the peripheral surface of the tool body. The other one cutting insert is referred to as a peripheral edge insert, and includes a long peripheral cutting edge that is located on an opposite side to a front surface cutting edge across a hole for a screw in a state where the center edge insert is turned 90° and the longitudinal and lateral sides are switched, and a short front surface cutting edge that is formed near a corner of the peripheral cutting edge.

Furthermore, such a cutting tool also uses a rectangular cutting insert of a so-called two-corner type that can be used both as a center edge and a peripheral edge by changing an orientation of one type of the cutting insert and attaching the cutting insert to a tool body, instead of preparing two types of cutting inserts of different shapes. A type whose cutting insert of such a two-corner type does not have symmetry between the top surface and the back surface (the type whose single surface alone can be used and that cannot be used by being turned over) can have a shape that uniquely defines a posture at which the cutting insert is mounted on an insert seat of a pocket, and therefore hardly causes confusion that an insert taking an incorrect posture is mounted on the insert seat while facing a wrong orientation.

Furthermore, the above cutting tool also uses a cutting insert of a so-called double-surface four-corner type that can be used both as the center edge and the peripheral edge by changing the orientation of one type of the cutting insert and mounting the cutting insert on the tool body, and can be used even when the top surface is turned over to the back surface, and such a rectangular cutting insert of the double-surface four-corner type needs to have symmetry between the top surface and the back surface. Therefore, this cutting insert is restricted in such a way to form a shape that uniquely defines a posture at which the cutting insert is mounted on an insert seat. Due to such a background, this cutting insert is more likely to cause a mounting mistake that the insert taking an incorrect posture is mounted on the insert seat while facing a wrong orientation than the above so-called two-corner type. There has been conventionally proposed a device of adopting a so-called dovetail structure for an insert seat to prevent such a mounting mistake (see, for example, Patent Publications JP 2021-30401A and JP 2001-328011A). In the dovetail structure, a constraint surface (the surface for constraining the motion of the cutting insert) inclines at an acute angle with respect to the bottom surface of the insert seat, and a wedge-shaped lower surface (or upper surface) and side surface of the cutting insert are brought into contact with these constraint surface and bottom surface to prevent the cutting insert from rising.

### SUMMARY

However, although prevention of the mounting mistake of the cutting insert has been taken into account so far as described above, as arrangement of cutting edges and an entire shape become more complicated, it becomes more difficult to find a right corner to use in a current situation. Particularly in a case where a pocket part that forms an insert seat has a simple rectangular shape, a cutting insert taking an incorrect posture is mounted without difficulty while facing a wrong orientation. Moreover, if the cutting insert seems to be clamped firmly, a user has difficulty in noticing a mounting mistake.

It is therefore an object of the present disclosure to provide a cutting tool and a tool body thereof that can further prevent a mounting mistake caused when a cutting insert is mounted on an insert seat by voluntarily improving a structure around the insert seat in particular.

An aspect of the present disclosure is a cutting tool including a tool body that includes an insert mounting part for mounting a cutting insert including an upper surface, a lower surface, a peripheral side surface, a cutting edge, and a hole for a screw, the peripheral side surface including curved corner parts, the cutting edge being formed at a part of an upper intersecting edge of the upper surface and the peripheral side surface, and a lower intersecting edge of the lower surface and the peripheral side surface, and the hole penetrating the upper surface to the lower surface, and the insert mounting part has a shape including a bottom surface that includes a female screw part for a fixing screw inserted in the hole, and comes into contact with at least a part of the upper surface or the lower surface of the cutting insert, a constraint surface that is a surface including a portion that comes into contact with at least a part of a constraint target surface formed as a surface of the peripheral side surface of the cutting insert inclining with respect to the upper surface or the lower surface, and whose inclination angle with respect to the bottom surface is an acute angle, an evacuation part that is formed at a part that the upper intersecting edge or the lower intersecting edge of the cutting insert approaches so as to have a shape that allows evacuation from the constraint surface hedging the cutting edge, a first protrusion area that extends hiding a part of the upper surface or the lower surface of the cutting insert mounted on the insert mounting part, as seen from a direction perpendicular to the bottom surface, a relief part that is formed at a part that the corner parts of the cutting insert approach so as to hedge the corner parts, and a second protrusion area that extends from an upper side of the relief part so as to cover a part of the upper surface or the lower surface of the cutting insert mounted on the insert mounting part, as seen from the direction perpendicular to the bottom surface.

The cutting tool according to this aspect adopts a so-called dovetail structure that the constraint surface of the insert mounting part inclines at the acute angle with respect to the bottom surface, and is provided with an area (first protrusion area) that protrudes toward the cutting insert, and the relief part formed so as to hedge the corner part is also provided with an area (second protrusion area) that protrudes toward the cutting insert. Therefore, when the insert taking an incorrect posture is mounted on an insert seat while facing a wrong orientation, these areas interfere with the constraint target surface of the insert, and the cutting insert is pushed out in a direction opposite to the constraint surface. As a result, the female screw part of the insert seat and the hole of the cutting insert are shifted by a predetermined amount, and it becomes difficult or impossible to fix the cutting insert by the fixing screw.

In the above cutting tool, the first protrusion area and/or the second protrusion area may be formed protruding to a position to which a center axis of the hole of the cutting insert seated at a posture that does not fit to the insert mounting part is shifted by at least a predetermined amount with respect to the female screw part.

In the above cutting tool, the first protrusion area may be formed on a surface extended from the constraint surface.

In the above cutting tool, an inclination angle of the first protrusion area and/or the second protrusion area with respect to the bottom surface may be such a degree of an angle that the cutting insert seated at the posture that does not fit to the insert mounting part is shifted by at least a predetermined amount from an appropriate seating position.

In the above cutting tool, a height of the first protrusion area and/or the second protrusion area from the bottom surface may be such a height that a center axis of the hole of the cutting insert seated at a posture that does not fit to the insert mounting part is shifted by at least a predetermined amount with respect to the female screw part.

In the above cutting tool, the predetermined amount may be a shift amount at which screwing, to the female screw part, the fixing screw inserted in the hole of the cutting insert is difficult.

The cutting insert of the above cutting tool may have a substantially rectangular shape in top view toward the upper surface and in bottom view toward the lower surface.

The upper surface and the lower surface of the cutting insert of the above cutting tool may each have a rectangular shape whose lengths of a first side of the upper intersecting edge or the lower intersecting edge, and a third side facing the first side are longer than lengths of a second side and a fourth side facing the second side.

In the above cutting tool, the constraint target surface may be formed on a surface of the peripheral side surface of the cutting insert adjacent to the second side or the fourth side, and the constraint surface of the insert mounting part may be formed at a position facing the constraint target surface.

In the above cutting tool, the constraint target surface may form a flank whose clearance angle is positive with respect to a cutting edge provided on the second side.

The cutting insert of the above cutting tool may have a shape whose height from the bottom surface to the upper intersecting edge or the lower intersecting edge in a state where the cutting insert is mounted on the insert mounting part gradually decreases from the hole to the fourth side.

In the above cutting tool, one of side surfaces of the peripheral side surface other than the constraint surface may form a flank whose clearance angle is negative with respect to a cutting edge provided on the first side.

The cutting insert of the above cutting tool adopts an axially symmetrical structure in which, when the cutting insert reversely rotates 180° about an×axis as a rotational center that is a perpendicular line passing a center of the center axis of the hole and extends along the second side and the fourth side, a side of the upper surface and a side of the lower surface have a same shape.

The cutting insert of the above cutting tool may adopt a structure in which three sides of four sides on the upper surface side and three sides of four sides on the lower surface side can be used as cutting edges.

The cutting insert of the above cutting tool may include cutting edges provided to two adjacent corner parts of the corner parts.

In the above cutting tool, the center axis of the hole may be perpendicular to the upper surface and the lower surface.

As the insert mounting part of the above cutting tool, two insert mounting parts on which the cutting inserts of a same shape are mounted at different postures and that have mutually different orientations are provided.

The two insert mounting parts of the above cutting tool may include a first insert mounting part on which the cutting insert is mounted at such a posture that long sides of four sides of the upper intersecting edge or the lower intersecting edge of the cutting insert are directed to a radial direction of the tool body, and a second insert mounting part on which the cutting insert is mounted at such a posture that the long sides are directed to a rotational axis direction of the tool body.

Another aspect of the present disclosure is a cutting tool including a tool body that includes an insert mounting part for mounting a cutting insert including an upper surface, a lower surface, a peripheral side surface, a cutting edge, and a hole for a screw, the peripheral side surface including curved corner parts, the cutting edge being formed at a part of an upper intersecting edge of the upper surface and the peripheral side surface, and a lower intersecting edge of the lower surface and the peripheral side surface, and the hole penetrating the upper surface to the lower surface, and the insert mounting part has a shape including a bottom surface that includes a female screw part for a fixing screw inserted in the hole, and comes into contact with at least a part of the upper surface or the lower surface of the cutting insert, a constraint surface that is a surface including a portion that comes into contact with at least a part of a constraint target surface formed as a surface of the peripheral side surface of the cutting insert inclining with respect to the upper surface or the lower surface, and whose inclination angle with respect to the bottom surface is an acute angle, a relief part that is formed at a part that the corner parts of the cutting insert approach so as to hedge the corner parts, and a protrusion area that extends from an upper side of the relief part so as to cover a part of the upper surface or the lower surface of the insert mounted on the insert mounting part.

Still another aspect of the present disclosure is a tool body constituting the above cutting tool.

### BRIEF DESCRIPTION OF DRAWINGS

FIG. 1 is a perspective view illustrating a cutting tool according to an embodiment of the present disclosure seen from a side of a leading end part of a body (tool body);

FIG. 2 is a perspective view illustrating a configuration of a pocket for a center edge insert (first insert mounting part);

FIG. 3 is a perspective view illustrating a configuration of a pocket for a peripheral edge insert (second insert mounting part);

FIG. 4 is a perspective view illustrating the shape of a cutting insert;

FIGS. 5A and 5B are a top view and a side view of the cutting insert used as the center edge insert;

FIG. 6 is a top view of the cutting insert used as the peripheral edge insert;

FIG. 7 is a view illustrating a leading end part of the cutting tool seen from a side of the pocket for the center edge insert;

FIG. 8 is a cross-sectional view taken along line VIII-VIII in FIG. 7;

FIG. 9 is a cross-sectional view taken along line IX-IX in FIG. 7;

FIG. 10A is a view illustrating a state where the cutting insert is mounted on the pocket for the center edge insert at a correct posture, and FIG. 10B is a view illustrating a state where the cutting insert is mounted at a wrong posture;

FIGS. 11A and 11B are views enlarging and illustrating part of FIG. 10A and part of FIG. 10B, respectively;

FIGS. 12A and 12B are views illustrating a state where a conventional cutting insert is mounted as a center edge insert on a pocket, and a state where the cutting insert of the cutting tool according to the present application is mounted as the center edge insert on the pocket, respectively, seen from a direction perpendicular to the upper surface of the cutting insert;

FIGS. 13A and 13B are views illustrating the state where the conventional cutting insert is mounted as the center edge insert on the pocket, and the state where the cutting insert of the cutting tool according to the present application is mounted as the center edge insert on the pocket, respectively, seen from a direction parallel to a constraint target surface of the cutting insert;

FIG. 14 is a perspective view illustrating the leading edge part of the cutting tool seen from a side provided with the pocket for the peripheral edge insert, and seen from a side of a base end part;

FIG. 15 is a view of the leading end part of the cutting tool seen from the side of the pocket for the peripheral edge insert;

FIG. 16 is a cross-sectional view taken along line XVI-XVI in FIG. 15;

FIG. 17 is a cross-sectional view taken along line XVII-XVII in FIG. 15;

FIG. 18A is a view illustrating a state where the cutting insert is mounted on the pocket for the peripheral edge insert at a correct posture, and FIG. 18B is a view illustrating a state where the cutting insert is mounted at a wrong posture;

FIGS. 19A and 19B are views illustrating a state where a conventional cutting insert is mounted as a peripheral edge insert in a pocket, and a state where the cutting insert of the cutting tool according to the present application is mounted as the peripheral edge insert on the pocket, respectively, seen from the direction perpendicular to the upper surface of the cutting insert;

FIGS. 20A and 20B are views illustrating the state where the conventional cutting insert is mounted as the peripheral edge insert on the pocket, and the state where the cutting insert of the cutting tool according to the present application is mounted as the peripheral edge insert on the pocket, respectively, seen from the direction parallel to the constraint target surface of the cutting insert; and

FIG. 21 is a view for describing a “shift amount” between the state where the cutting insert is mounted on the pocket at the correct posture and the state where the cutting insert is mounted on the pocket at the wrong posture using a mathematical formula.

### DETAILED DESCRIPTION

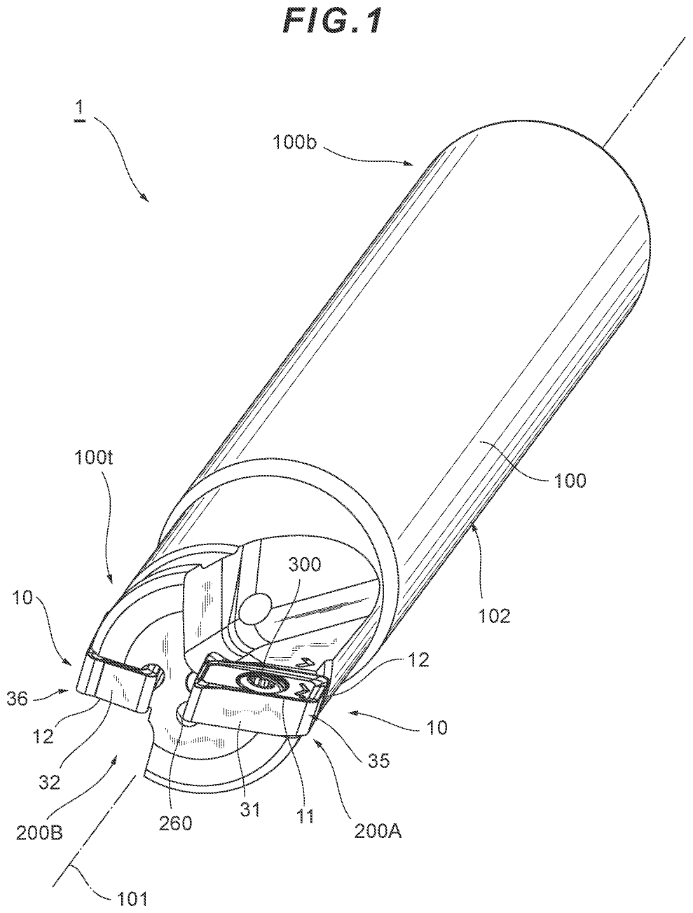

Hereinafter, a preferred embodiment of a cutting tool and a body (tool body) thereof according to the present disclosure will be described in detail with reference to the drawings (see, for example, FIG. 1).

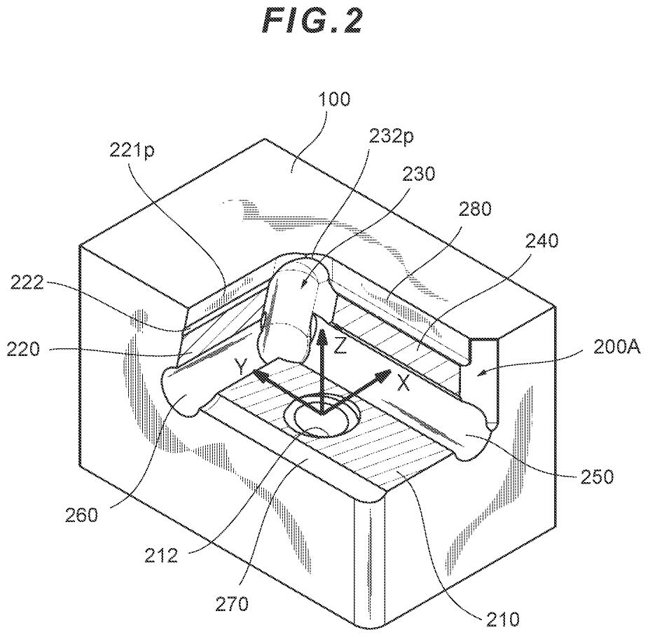

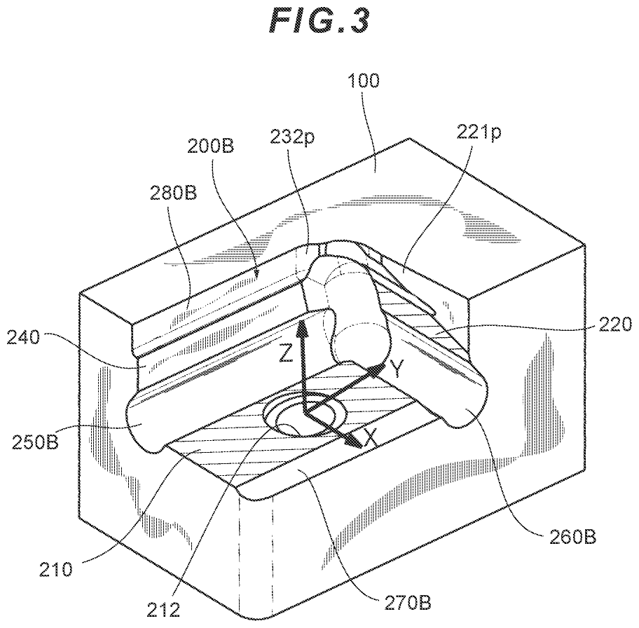

A cutting tool 1 is a tool that is formed by mounting a cutting insert 10 on pockets (insert mounting parts that constitute a so-called insert seat) 200 of a body (tool body) 100, and is used as a cutting tool for milling such as an end mill. The cutting tool 1 according to the present embodiment includes the two pockets 200 arranged sandwiching a rotational axis 101 at a leading end part 100t (a base end part is denoted by 100b) of the body 100 (see, for example, FIG. 1). These two pockets 200 include a first insert mounting part 200A and a second insert mounting part 200B formed such that a rectangular cutting insert of a so-called double-surface four-corner type (that is an insert of a structure that the insert can be used by being turned 90° about a hole 40 for a fixing screw 300 and switching longitudinal and lateral sides, and can be used by turning over top and back surfaces and reversing an upper surface 18 and a lower surface 28, and four corner parts in total are cutting edges) 10 can be mounted on the first insert mounting part 200A and the second insert mounting part 200B at different postures. The first insert mounting part 200A is a pocket on which the cutting insert 10 is mounted at a posture with a longitudinal direction of the cutting insert 10 directed perpendicularly with respect to the rotational axis 101 (in other words, a posture with a long side directed to a radial direction of the body 100), and is referred to as a pocket of a center edge insert (or a pocket of an A edge insert) in some cases in this description (see FIG. 2). The second insert mounting part 200B is a pocket on which the cutting insert 10 is mounted at a posture with the longitudinal direction of the cutting insert 10 directed horizontally to the rotational axis 101 (in other words, a posture with the long side directed to a direction of a rotational axis 101 of the body 100), and is referred to as a pocket of a peripheral edge insert (or a pocket of a B edge insert) in some cases in this description (see FIG. 3).

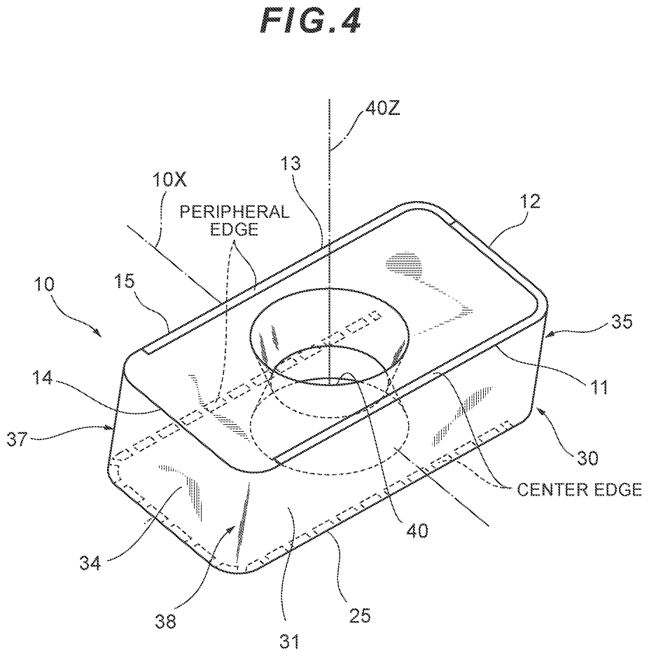

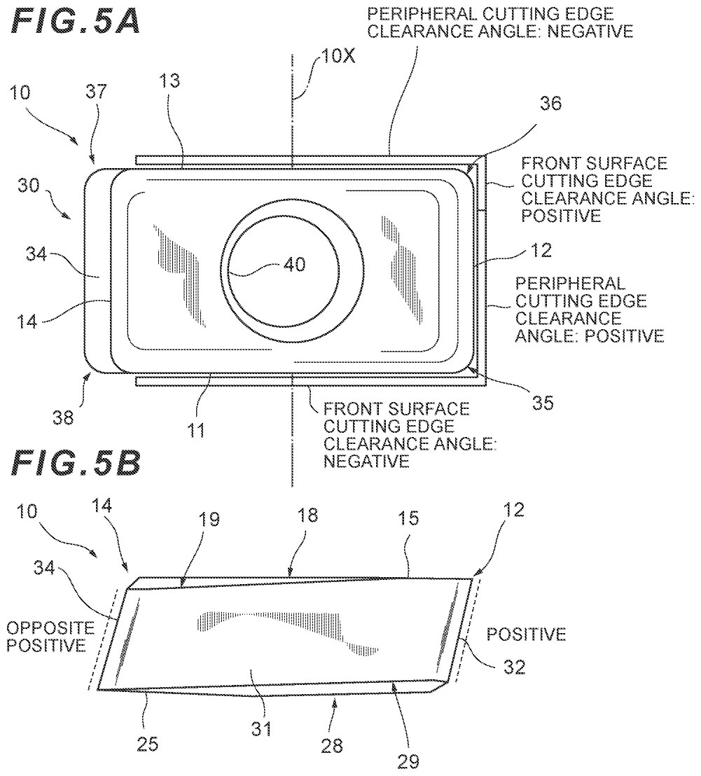

The cutting insert 10 is the rectangular insert of the double-surface four-corner type as described above, and includes the upper surface 18, the lower surface 28, a peripheral side surface 30 including curved corner parts 35, 36, 37, and 38, a cutting edge that is formed at part of an upper intersecting edge of the upper surface 18 and the peripheral side surface 30 and a lower intersecting edge of the lower surface 28 and the peripheral side surface 30, the hole 40 that penetrates the upper surface 18 to the lower surface 28, and gradually decreased parts 19 and 29 (see, for example, FIG. 4). This cutting insert 10 is substantially rectangular in top view toward the upper surface 18 and in bottom view toward the lower surface 28. The peripheral side surface 30 includes a first side surface 31, a second side surface (constraint target surface) 32, a third side surface 33, and a fourth side surface (constraint target surface) 34 (see, for example, FIG. 4). As for the upper intersecting edge of the upper surface 18 and the peripheral side surface 30, a part in contact with the first side surface 31 is a first side 11, a part in contact with the second side surface 32 (constraint target surface) is a second side 12, a part in contact with the third side surface 33 is a third side 13, and a part in contact with the fourth side surface (constraint target surface) 34 is a fourth side 14 (see FIGS. 4, 5A, and 5B). The first side 11 and the third side 13 are long sides longer than the second side 12 and the fourth side 14, and the second side 12 and the fourth side 14 are short sides shorter than the first side 11 and the third side 13. Note that each side that forms the lower intersecting edge of the lower surface 28 and the peripheral side surface 30 employs the same configuration as that of the upper surface 18, and therefore is not defined intentionally in this description. Hereinafter, description will continue based on a state where the upper surface 18 is on the upper side (or located on a visible side) in the figures.

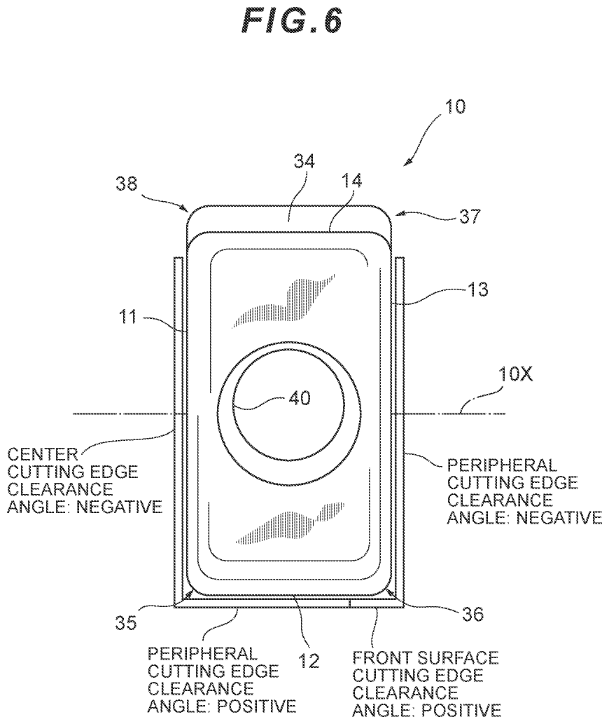

The cutting insert 10 according to the present embodiment can be used as the “center edge insert” at a posture with the longitudinal direction (a direction in which the first side 11 and the third side 13 that are the long sides extend) directed laterally (a posture with the longitudinal direction directed perpendicularly with respect to the rotational axis 101) (see FIGS. 5A and 5B), and can be used as the “peripheral edge insert” at a posture with the longitudinal direction directed longitudinally (the posture with the longitudinal direction directed in parallel to the rotational axis 101) (see FIG. 6). The cutting insert 10 that is the center edge insert is mounted on the center edge insert pocket (the pocket of the A edge insert) 200A, and the cutting insert 10 that is the peripheral edge insert is mounted on the peripheral edge insert pocket (the pocket of the B edge insert) 200B (see, for example, FIGS. 1 to 3). The cutting insert 10 according to the present embodiment is formed as the center cutting edge (also referred to as a front surface cutting edge) whose cutting edge formed on the first side 11 extends from a peripheral surface 102 of the body 100 to the rotational axis 101 when used as the “center edge insert”, and the short peripheral cutting edge whose cutting edge formed on the second side 12 with the corner part 35 interposed therebetween is located on the peripheral surface 102 of the body 100 (see FIGS. 5A and 5B). In the present embodiment, the second side surface 32 is formed to form a flank whose clearance angle is positive with respect to the short peripheral cutting edge formed on the second side 12 (see, for example, FIGS. 5A and 5B). Note that the second side surface 32 that is the flank of the positive clearance angle is a constraint target surface of an “opposite positive” clearance angle whose inclination is exact opposite when reversed (see FIGS. 5A and 5B). Furthermore, in the present embodiment, the first side surface 31 or the third side surface 33 is formed as the flank whose clearance angle θ of the center cutting edge (front surface cutting edge) is negative (“negative” usually means a negative angle (so-called opposite positive), yet is used as a term including a case where the clearance angle is 0 degree, and exemplifies a case where the clearance angle is 0 degree in the present embodiment in particular). Furthermore, when used as the “peripheral edge insert”, this cutting insert 10 is formed such that the cutting edge formed on the third side 13 is the long peripheral cutting edge that is located on the peripheral surface 102 of the body 100, and the cutting edge on the second side 12 located nearby with the corner part 36 of this peripheral cutting edge interposed therebetween is the short front surface cutting edge (see FIG. 6). In other words, the cutting insert 10 according to the present embodiment adopts a structure that the three sides of the four sides (the first side 11, the second side 12, the third side 13, and the fourth side 14) on the upper surface 18 side, and the three sides of the four sides (that are not denoted by reference numerals in particular in the figures) on the lower surface 28 side can be used as the cutting edges.

The gradually decreased part 19 is a part formed such that the height of the upper intersecting edge 15 from the lower surface 28 gradually decreases from the hole 40 toward the fourth side 14 (see, for example, FIGS. 5A and 5B). Thus, the gradually decreased part 19 has the shape formed by making part of the upper surface 18 lower on the side opposite to the cutting edge (peripheral cutting edge) formed on the second side 12, so that the vicinity of the center cutting edge of the center edge insert (A edge insert) becomes thin, and ejection performance of chips produced when, for example, the cutting insert 10 performs hole drilling improves. Naturally, the similar gradually decreased part 29 is also formed on the lower surface 28 side (see FIG. 5B).

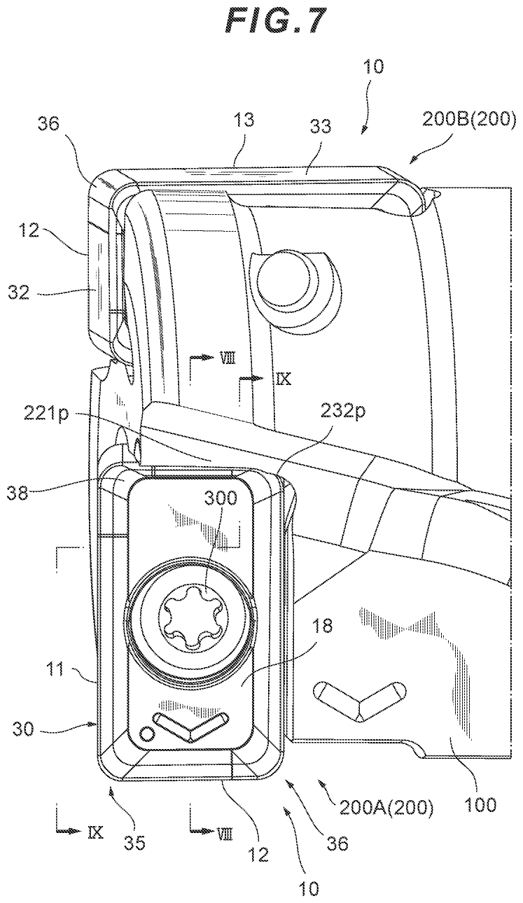

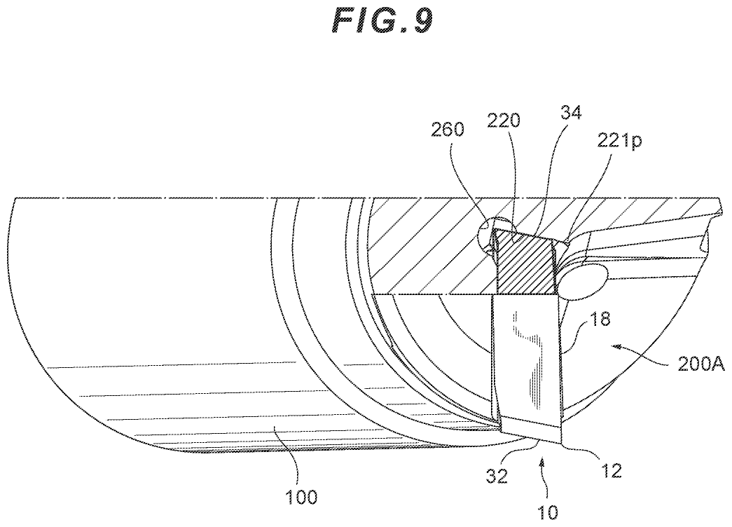

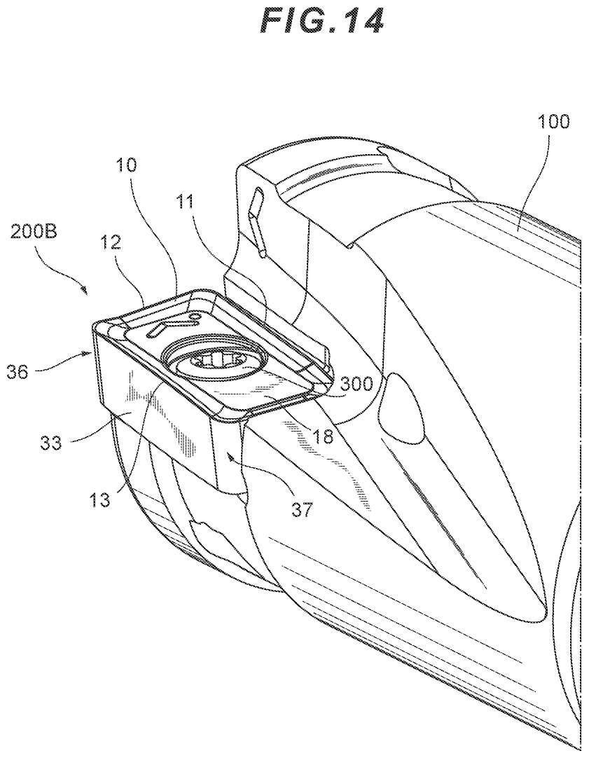

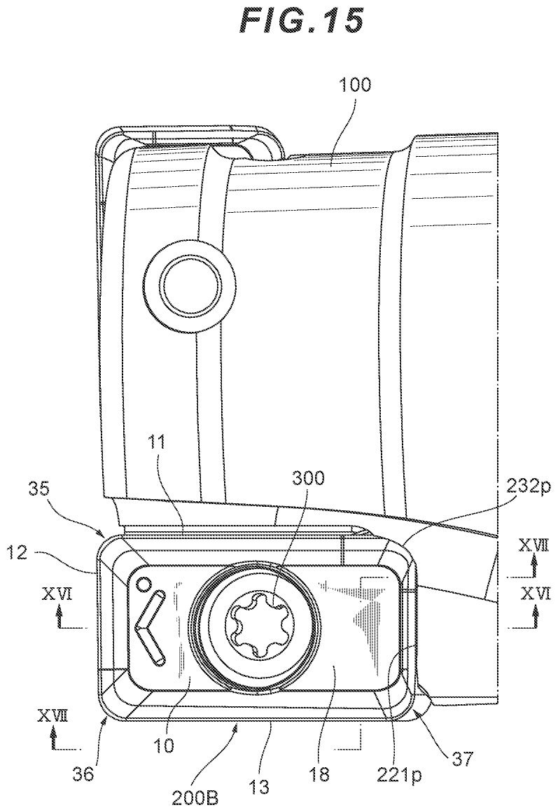

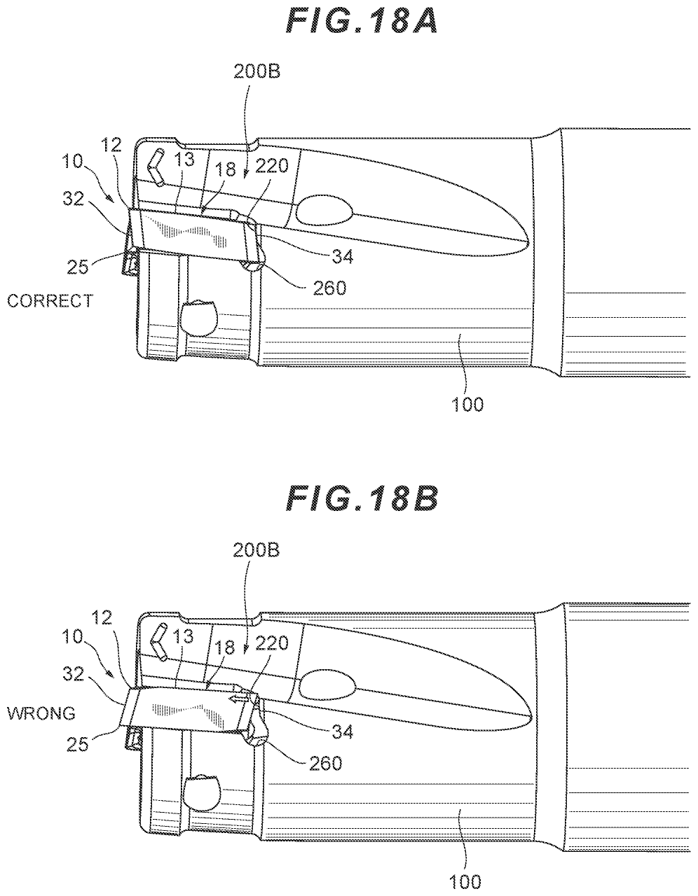

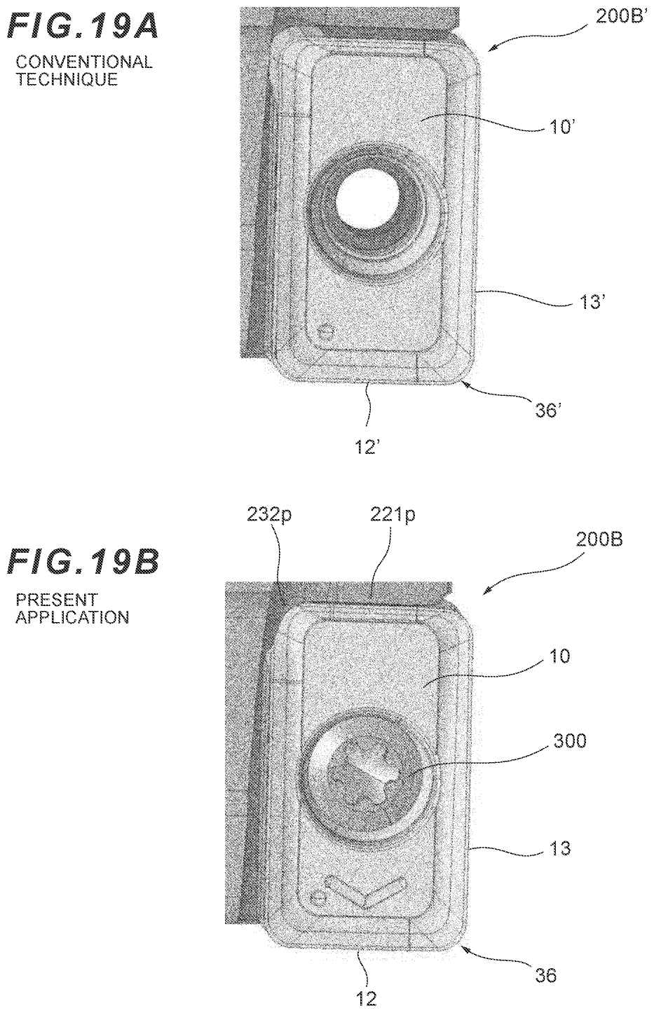

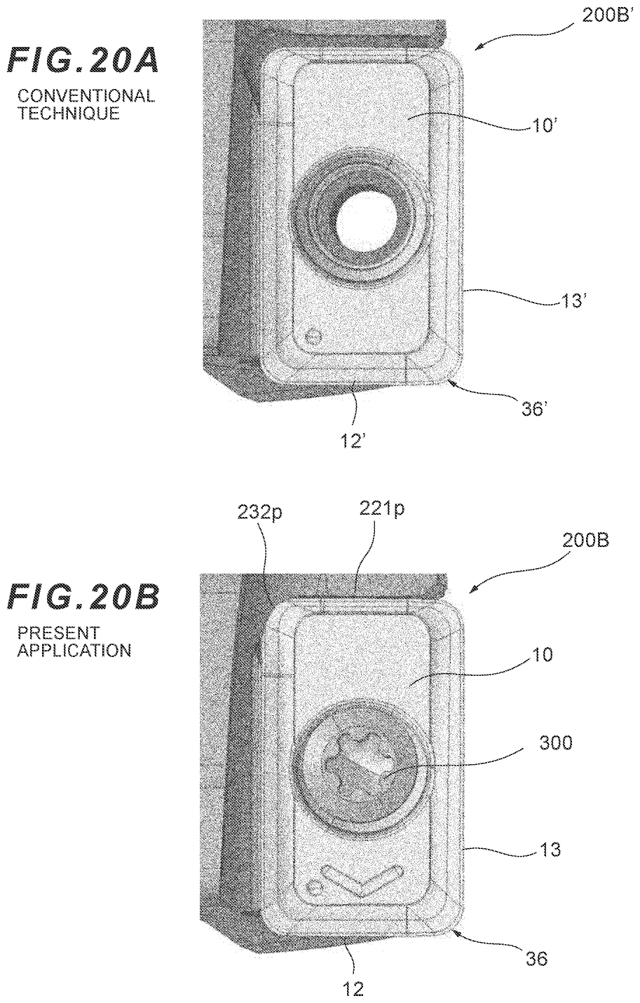

To provide symmetry for enabling use of both of the upper surface 18 side and the lower surface 28 side likewise, the above cutting insert 10 of the double-surface four-corner type is formed in an axially symmetrical structure that has the same shape on the upper surface 18 side and the lower surface 28 side when the cutting insert 10 reversely rotates 180° about the rotational center of an X axis 10X (see FIG. 4) that is a perpendicular line passing the center of a center axis 40Z of the hole 40 and extends along the second side 12 and the fourth side 14. Therefore, the cutting insert 10 is restricted in such a way to form a shape that uniquely defines the posture at which the cutting insert 10 is mounted on the pockets 200 (200A and 200B), and may cause a mounting mistake that the cutting insert 10 is mounted while taking an incorrect posture. The cutting tool 1 and the tool body 100 thereof according to the present embodiment can further prevent such a mounting mistake of the cutting insert 10 by voluntarily improving the structure of the pockets 200 and, above all, the structure around a constraint surface 220 as described later. Hereinafter, the structure of the center edge insert pocket (the pocket of the A edge insert) 200A will be described first (see FIGS. 7 to 9, 10A, 10B, 11A, 11B, 12A, 12B, 13A, and 13B). Next, the structure of the peripheral edge insert pocket (the pocket of the B edge insert) 200B will be described (see FIGS. 14 to 17, 18A, 18B, 19A, 19B, 20A, and 20B). Note that the structures of these pockets 200 will be described by defining for the sake of convenience a direction along a lateral direction (a direction in which the second side 12 and the fourth side 14 that are the short sides extend) of the cutting insert 10 mounted on the pocket 200 as an X direction, the direction along the longitudinal direction (the direction in which the first side 11 and the third side 13 that are the long sides extend) as a Y direction, and a direction perpendicular to a bottom surface 210 as a Z direction (see FIGS. 2 and 3).

Structure of Center Edge Insert Pocket (Pocket of an Edge Insert) 200A

The center edge insert pocket 200A is formed in a shape including the bottom surface 210, the constraint surface 220, an evacuation part 222, a first protrusion area 221p, a relief part 230, and a second protrusion area 232p, and further including a contact surface 240, clearance parts 250, 260, 270, and an evacuation part 280 (see, for example, FIGS. 2 and 7).

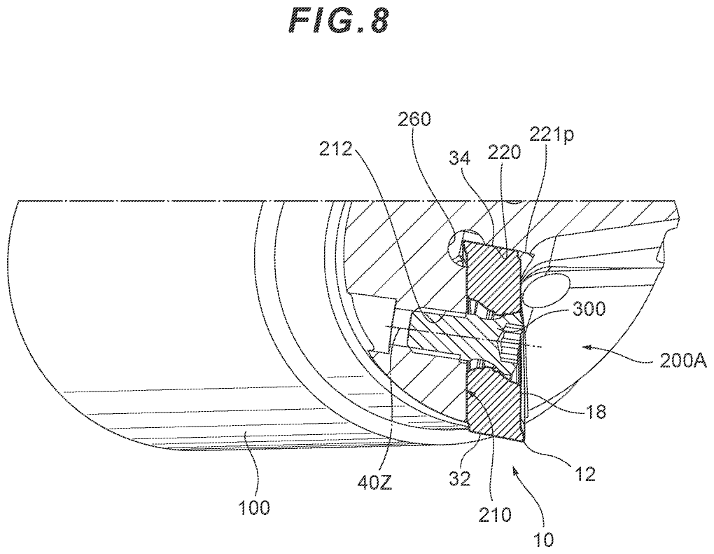

The bottom surface 210 is a surface that constitutes a so-called insert seat and comes into contact with at least part of the upper surface 18 or the lower surface 28 of the cutting insert 10 (see, for example, FIGS. 2, 8, and 9). The bottom surface 210 is provided with a female screw part 212. By screwing to this hole 40 a leading end part of the fixing screw 300 inserted in the hole 40 of the cutting insert 10, the cutting insert 10 is mounted on this center edge insert pocket 200A (see, for example, FIG. 8). Note that the cutting insert 10 whose center axis 40Z of the hole 40 inclines with respect to the upper surface 18 and the lower surface 28 (i.e., do not match in the Z direction) is used, and therefore the above female screw part 212 also inclines with respect to the bottom surface 210 likewise in the present embodiment (see, for example, FIG. 8). However, the present embodiment is merely an example. In a case where the cutting insert 10 whose center axis 40Z of the hole 40 is perpendicular with respect to the upper surface 18 and the lower surface 28 is used, the female screw part 212 may be arranged perpendicularly with respect to the bottom surface 210.

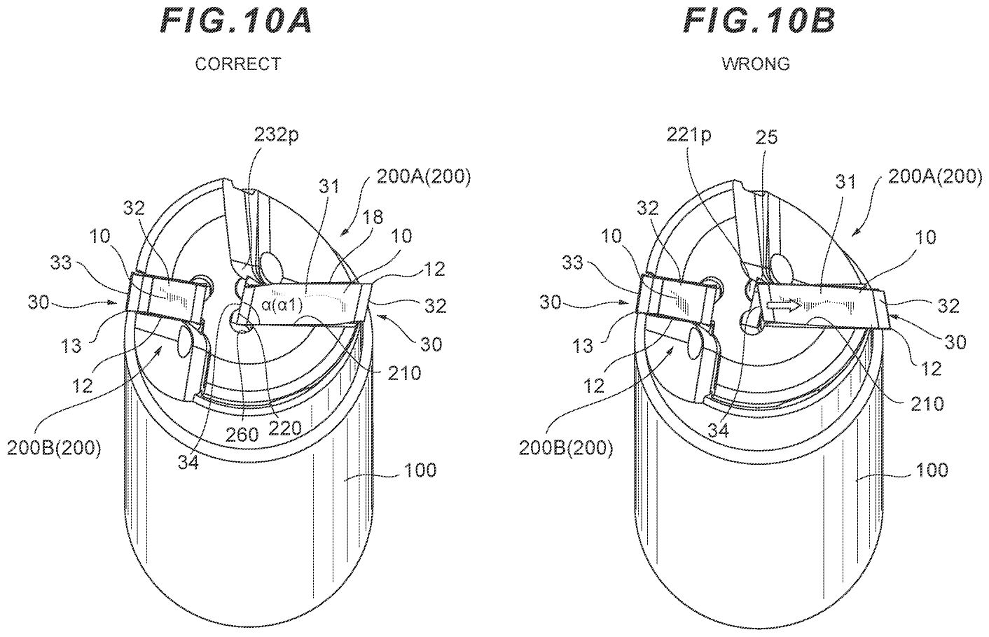

The constraint surface 220 is a surface that faces the second side surface (constraint target surface) 32 or the fourth side surface (constraint target surface) 34 (hereinafter, these surfaces will be referred to simply as the “constraint target surfaces” in some cases) of the cutting insert 10, and includes portions that come into contact with at least part of these constraint target surfaces 32 and 34, and defines a position in the Y direction of the cutting insert 10 when coming into contact with the constraint target surfaces 32 and 34 (see, for example, FIGS. 2 and 8). In the present embodiment, this constraint surface 220 is formed as a surface whose inclination angle α (α1) with respect to the bottom surface 210 is an acute angle to construct a so-called dovetail structure (a structure that the constraint surface 220 is inclined at the acute angle with respect to the bottom surface 210 to place the wedge-shaped lower surface 28 (or upper surface 18) of the cutting insert 10 and the constraint target surface 34 (or constraint target surface 32) in contact with these surfaces, and thereby prevent the cutting insert 10 from rising) (see, for example, FIGS. 10A and 10B).

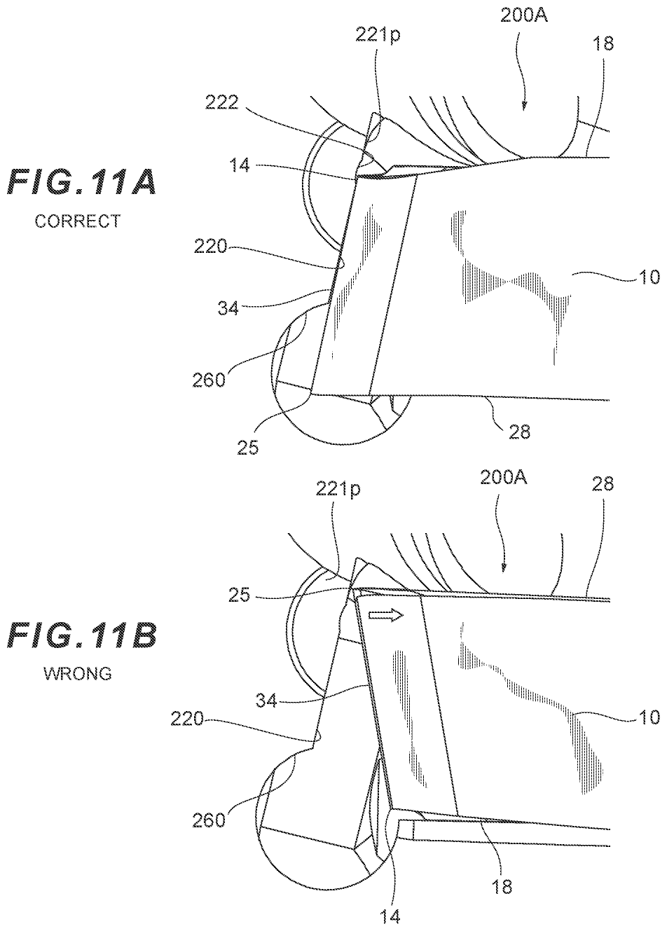

The evacuation part 222 is formed as a recessed part that is formed at a part that the upper intersecting edge 15 or the lower intersecting edge 25 of the cutting insert 10 approaches (see, for example, FIGS. 11A and 11B). This evacuation part 222 is formed in a shape to allow evacuation from the constraint surface 220 (or an extended surface of the constraint surface 220) hedging the upper intersecting edge 15 or the lower intersecting edge 25, and is not contacted by the upper intersecting edge 15 or the lower intersecting edge 25 of the cutting insert 10 mounted on the center edge insert pocket 200A.

The first protrusion area 221p is an area that extends and protrudes hiding part of the upper surface 18 or the lower surface 28 of the cutting insert 10 mounted on the center edge insert pocket 200A when the center edge insert pocket 200A is seen from the direction perpendicular to the bottom surface 210 (in other words, along the Z direction). For example, the first protrusion area 221p according to the present embodiment is formed on a surface extended from the constraint surface 220 to a position beyond the evacuation part 222 (see, for example, FIGS. 11A and 11B).

The relief part 230 is a part that includes a recessed part formed at a part that the corner part of the cutting insert 10 approaches so as to hedge the corner part (see, for example, FIG. 2). For example, in the present embodiment, the relief part 230 is provided at a part of the corner of the center edge insert pocket 200A to hedge contact of the corner part 35 or the corner part 37 of the cutting insert 10.

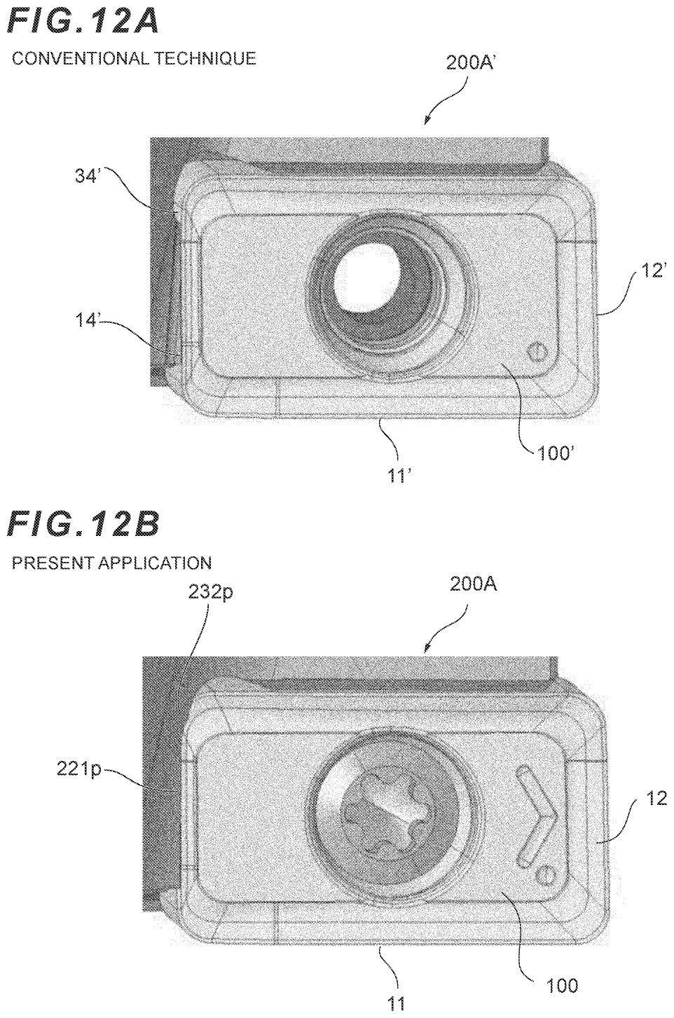

The second protrusion area 232p is an area that extends from an upper side of the relief part 230 and protrudes covering part of the upper surface 18 or the lower surface 28 of the cutting insert 10 mounted on the center edge insert pocket 200A when the center edge insert pocket 200A is seen from the direction perpendicular to the bottom surface 210 (in other words, along the Z direction) (see, for example, FIGS. 2 and 12B. Note that in FIG. 12A and the like illustrating a conventional structure for reference, corresponding reference numerals are assigned′ (dash)). For example, in the present embodiment, when seen along the Z direction, the second protrusion area 232p protrudes along the Y direction beyond the edge of the first protrusion area 221p (see, for example, FIG. 12B).

The contact surface 240 is a surface that part of surfaces (i.e., the first side surface 31 and the third side surface 33) of the peripheral side surface 30 of the cutting insert 10 except the constraint surfaces 32 and 34 come into contact with (see, for example, FIG. 2). The contact surface 240 of the body 100 according to the present embodiment is formed as a surface that is substantially perpendicular with respect to the bottom surface 210.

The clearance part 250 is formed in a groove shape between the contact surface 240 and the bottom surface 210 at a part at which the peripheral cutting edge on the long side that is not used as the cutting edge of the cutting insert 10 (e.g., the peripheral cutting edge for the peripheral edge insert (B edge insert) formed on the third side 13 of the upper surface 18 (see FIG. 6)) is provided without coming into contact with the center edge insert pocket 200A (see, for example, FIG. 2).

The clearance part 260 is formed in a groove shape between the constraint surface 220 and the bottom surface 210 at a part at which the peripheral cutting edge on the short side that is not used as the cutting edge of the cutting insert 10 (e.g., the peripheral cutting edge for the center edge insert (A edge insert) formed on the second side 12 of the upper surface 18 (see FIGS. 5A and 5B)) is provided without coming into contact with the center edge insert pocket 200A (see, for example, FIG. 2).

The clearance part 270 is formed in a groove shape from the bottom surface 210 to the leading end part 100t of the body 100 at a part at which the center cutting edge on the long side that is not used as the cutting edge of the cutting insert 10 (e.g., the center cutting edge for the center edge insert (A edge insert) formed on the first side 11 of the upper surface 18 (see FIGS. 5A and 5B)) is provided without coming into contact with the center edge insert pocket 200A (see, for example, FIG. 2).

The evacuation part 280 is formed as a recessed part of a groove shape on a side of the contact surface 240 opposite to the bottom surface 210 at a part at which the peripheral cutting edge on the long side that is not used as the cutting edge of the cutting insert 10 (e.g., the peripheral cutting edge for the peripheral edge insert (B edge insert) formed on the third side 13 of the upper surface 18 (see FIG. 6)) is provided without coming into contact with the center edge insert pocket 200A (see, for example, FIG. 2).

According to the body 100 or the cutting tool 1 according to the present embodiment, the pocket 200A of the center edge insert (A edge insert) adopts the so-called dovetail structure that the constraint surface 220 thereof inclines at the acute angle with respect to the bottom surface 210, the first protrusion area 221p that protrudes toward the cutting insert 10 is provided at part of or on an extension line of the constraint surface 220, and the relief part 230 formed to hedge the corner part 37 (36) is provided with the second protrusion area 232p that protrudes toward the cutting insert 10. Therefore, when the cutting insert 10 taking an incorrect posture is mounted on the pocket 200A while facing a wrong orientation, these areas 221p and 232p interfere with the constraint target surface 32 (34) of the cutting insert 10, and the cutting insert 10 is pushed out and shifted by a predetermined amount in a direction opposite to the constraint surface 220 (i.e., a direction toward the peripheral surface 102 of the body 100) (see FIGS. 10A, 10B, 11A, and 11B). As a result, the female screw part 212 of the pocket 200A and the hole 40 of the cutting insert 10 are shifted by the predetermined amount, and therefore it becomes difficult or impossible to fix the cutting insert 10 with the fixing screw 300.

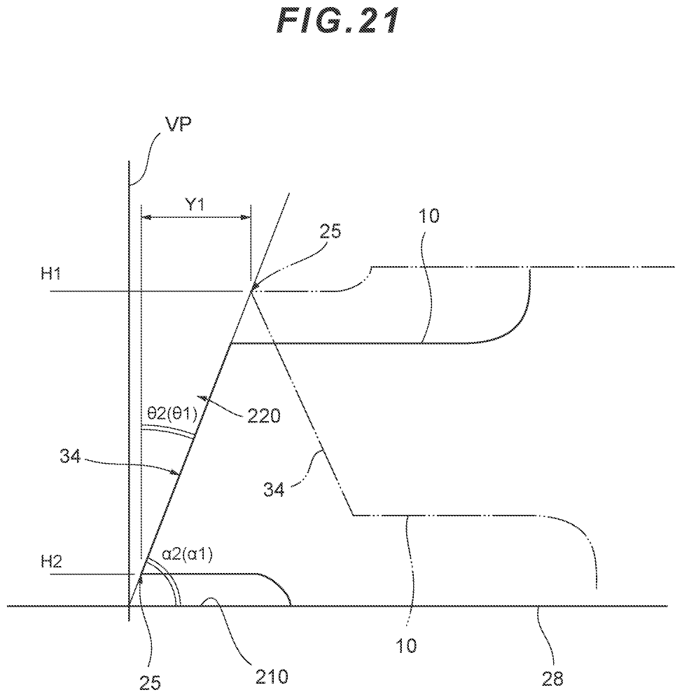

Thus, although the above predetermined amount is basically at least an amount that makes it difficult to screw to the female screw part 212 the fixing screw 300 inserted in the hole 40 of the cutting insert 10, a value of the predetermined amount can be appropriately set without departing from the features of the present disclosure by setting to a value of a suitable range an inclination angle α2 of the first protrusion area 221p with respect to the bottom surface 210 or setting to a value of a suitable range a height H of the first protrusion area 221p/second protrusion area 232p from the bottom surface 210. An outline of such settings will be described below with reference to a schematic diagram (see FIG. 21).

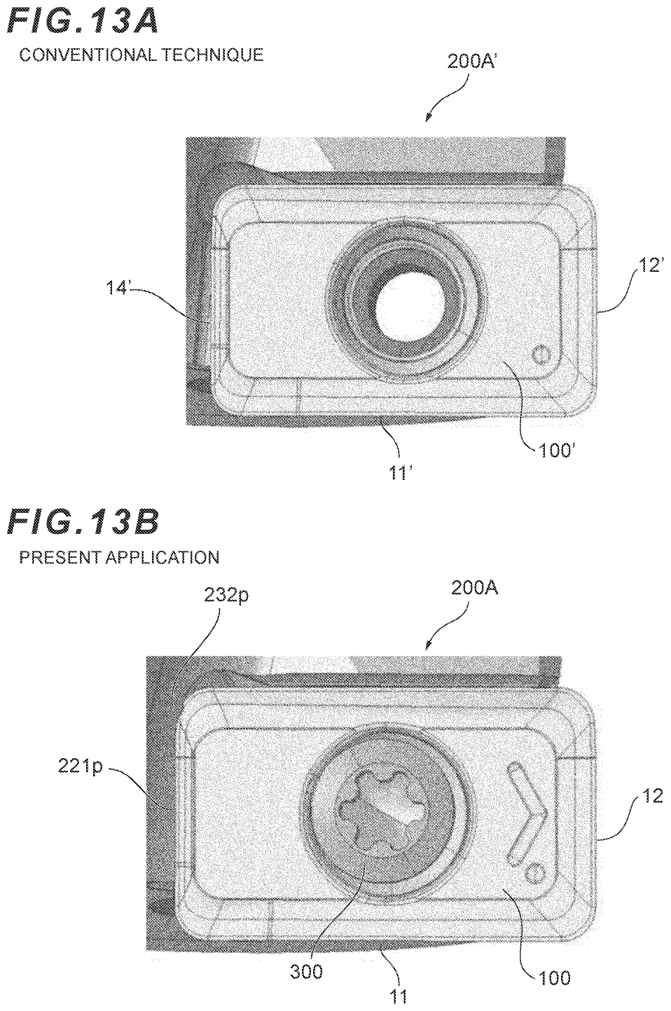

The cutting insert 10 and the pockets 200 according to the present embodiment adopt the dovetail structure as described above, and therefore the constraint surface 220 and the first protrusion area 221p incline at the inclination angles α1 and a2, respectively, with respect to the bottom surface 210. Angles 81 and 82 that are complementary angles of these inclination angles α1 and a2, that is, angles of the constraint surface 220 and the first protrusion area 221p in a case where a vertical plane VP (or a plane parallel thereto) with respect to the bottom surface 210 is zero degree are defined. Then, it is assumed that a height at a part at which the cutting insert 10 taking non-fitting posture (wrong posture) interferes with (contacts) the first protrusion area 221p is H1, and a height of an intersecting edge 25 (15) of the cutting insert 10 on the bottom surface 210 side in a case where the cutting insert 10 is mounted at a correct posture is H2. The cutting insert 10 and the center axis 40X of the hole 40 thereof are shifted along the Y direction by a dimension (shift amount) of (H1−H2)×tanθ2=Y1 (see FIG. 21). Furthermore, as for the relief part 230, although the corner part 37 (36) of the cutting insert 10 is accommodated in the relief part 230 if the cutting insert 10 is mounted at the correct posture, the corner part 35 (38) interferes with the second protrusion area 232p if the cutting insert 10 is mounted at a non-fitting posture (wrong posture), and the cutting insert 10 and the center axis 40X of the hole 40 thereof are shifted along the Y direction after all (see, for example, FIGS. 11A, 11B, 13A, and 13B). In a state where the center axis 40X of the hole 40 is shifted along the Y direction in this case, it is difficult to screw the leading end part of the fixing screw 300 to the female screw part 212.

Note that the present embodiment has been described by exemplifying a structure (a1=a2) that the inclination angle α1 of the constraint surface 220 and the inclination angle α2 of the first protrusion area 221p are equal. However, this structure is merely an example. It can be said that such a structure is a structure that makes it easy to be manufactured by arranging the constraint surface 220 and the first protrusion area 221 on the same plane. However, a structure that the inclination angle α1 of the constraint surface 220 and the inclination angle α2 of the first protrusion area 221p are different (α1≠α2) such as α1>α2 may be adopted to form such a shape that the first protrusion area 221p further protrudes. Alternatively, the constraint surface 220 and the first protrusion area 221 may have shapes other than the planar shapes.

Structure of Peripheral Edge Insert Pocket (Pocket of B Edge Insert) 200B

Similar to the center edge insert pocket 200A, the peripheral edge insert pocket 200B can have a shape including the bottom surface 210, the constraint surface 220, the evacuation part 222, the first protrusion area 221p, the relief part 230, the second protrusion area 232p, the contact surface 240, the clearance parts 250B, 260B, and 270B, and an evacuation part 280B (see FIGS. 3, 14 to 17, 18A, 18B, 19A, 19B, 20A, and 20B). This peripheral edge insert pocket 200B shifts the cutting insert 10 taking a non-fitting posture (wrong posture) in the Y direction by a predetermined amount similar to the center edge insert pocket 200A. In this regard, what greatly differs is that, while this Y direction is the radial direction of the body 100 in a case of the center edge insert pocket 200A (see FIG. 2), the Y direction is a direction facing the leading end part 100t of the body 100 (in other words, a direction parallel to the rotational axis 101 of the body 100) in a case of the peripheral edge insert pocket 200B. What does not basically change is that, in a case where the cutting insert 10 taking a non-fitting posture (wrong posture) is mounted, the cutting insert 10 and the center axis 40X of the hole 40 thereof are shifted along the Y direction. In view of this point, this description will omit detailed description of the peripheral edge insert pocket 200B.

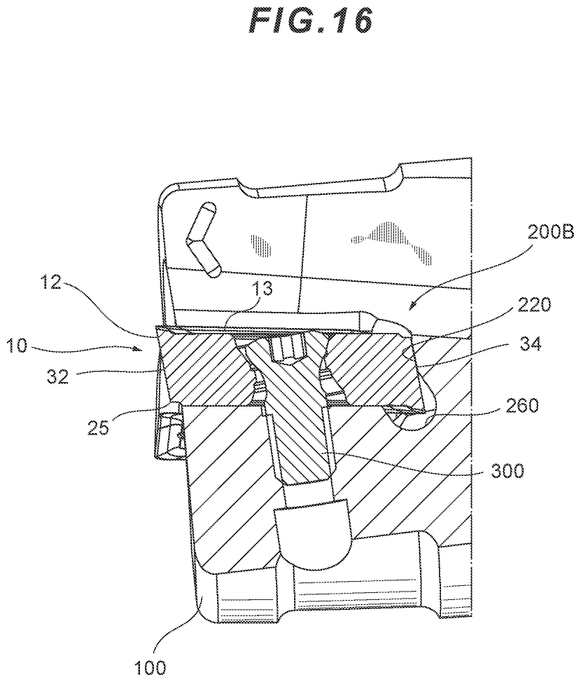

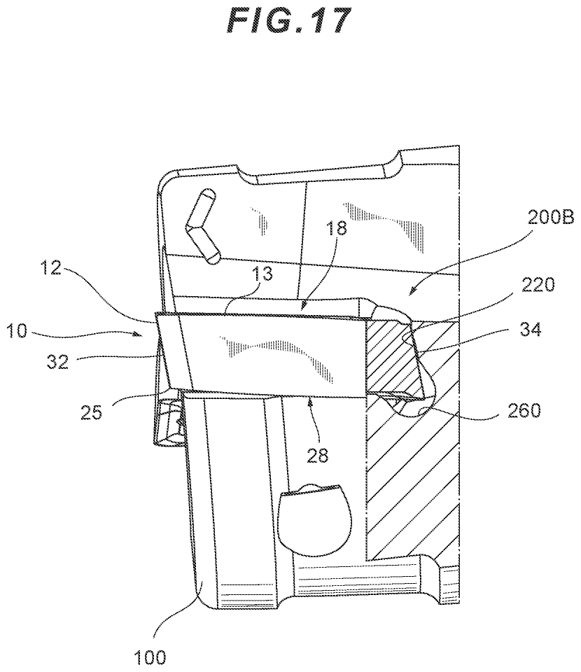

Note that the drawings illustrate the peripheral edge insert pocket (the pocket of the B edge insert) 200B that has the smaller first protrusion area 221p than that of the center edge insert pocket (the pocket of the A edge insert) 200A and does not have the evacuation part 22 (see, for example, FIGS. 16 and 17). It can be said that this peripheral edge insert pocket 200B has improved ejection performance of chips produced at the time of cutting, and, from a view point that, even if the first protrusion area 221p is small (a protrusion amount is small), the cutting insert 10 and the center axis 40X of the hole 40 thereof are shifted along the Y direction in a case where the cutting insert 10 taking a non-fitting posture (wrong posture) is mounted, the function of the peripheral edge insert pocket 200B can be exhibited.

Note that the above-described embodiment is an example of the preferred embodiment of the present disclosure, yet is not limited thereto, and can be variously modified and carried out without departing from the gist of the present disclosure.

The present disclosure is suitably applied to a cutting tool and a tool body thereof such as a multifunction cutter with a center edge.

What is claimed is:

1. A cutting tool comprising a tool body that includes an insert mounting part for mounting a cutting insert including an upper surface, a lower surface, a peripheral side surface, a cutting edge, and a hole for a screw, the peripheral side surface including curved corner parts, the cutting edge being formed at a part of an upper intersecting edge of the upper surface and the peripheral side surface, and a lower intersecting edge of the lower surface and the peripheral side surface, and the hole penetrating the upper surface to the lower surface,
wherein the insert mounting part has a shape including
a bottom surface that includes a female screw part for a fixing screw inserted in the hole, and comes into contact with at least a part of the upper surface or the lower surface of the cutting insert,
a constraint surface that is a surface including a portion that comes into contact with at least a part of a constraint target surface formed as a surface of the peripheral side surface of the cutting insert inclining with respect to the upper surface or the lower surface, and whose inclination angle with respect to the bottom surface is an acute angle,
an evacuation part that is formed at a part that the upper intersecting edge or the lower intersecting edge of the cutting insert approaches so as to have a shape that allows evacuation from the constraint surface hedging the cutting edge,
a first protrusion area that extends hiding a part of the upper surface or the lower surface of the cutting insert mounted on the insert mounting part, as seen from a direction perpendicular to the bottom surface,
a relief part that is formed at a part that the corner parts of the cutting insert approach so as to hedge the corner parts, and
a second protrusion area that extends from an upper side of the relief part so as to cover the part of the upper surface or the lower surface of the cutting insert mounted on the insert mounting part, as seen from the direction perpendicular to the bottom surface.

2. The cutting tool according to claim 1, wherein the first protrusion area and/or the second protrusion area are formed protruding to a position to which a center axis of the hole of the cutting insert seated at a posture that does not fit to the insert mounting part is shifted by at least a predetermined amount with respect to the female screw part.

3. The cutting tool according to claim 1, wherein the first protrusion area is formed on a surface extended from the constraint surface.

4. The cutting tool according to claim 3, wherein an inclination angle of the first protrusion area and/or the second protrusion area with respect to the bottom surface is such a degree of an angle that the cutting insert seated at the posture that does not fit to the insert mounting part is shifted by at least a predetermined amount from an appropriate seating position.

5. The cutting tool according to claim 1, wherein a height of the first protrusion area and/or the second protrusion area from the bottom surface is such a height that a center axis of the hole of the cutting insert seated at a posture that does not fit to the insert mounting part is shifted by at least a predetermined amount with respect to the female screw part.

6. The cutting tool according to claim 2, wherein the predetermined amount is a shift amount at which screwing, to the female screw part, the fixing screw inserted in the hole of the cutting insert is difficult.

7. The cutting tool according to claim 6, wherein the cutting insert has a substantially rectangular shape in top view toward the upper surface and in bottom view toward the lower surface.

8. The cutting tool according to claim 7, wherein the upper surface and the lower surface of the cutting insert each have a rectangular shape whose lengths of a first side of the upper intersecting edge or the lower intersecting edge, and a third side facing the first side are longer than lengths of a second side and a fourth side facing the second side.

9. The cutting tool according to claim 8, wherein the constraint target surface is formed on a surface of the peripheral side surface of the cutting insert adjacent to the second side or the fourth side, and the constraint surface of the insert mounting part is formed at a position facing the constraint target surface.

10. The cutting tool according to claim 9, wherein the constraint target surface forms a flank whose clearance angle is positive with respect to a cutting edge provided on the second side.

11. The cutting tool according to claim 10, wherein the cutting insert has a shape whose height from the lower surface to the upper intersecting edge or whose height from the upper surface to the lower intersecting edge gradually decreases from the hole to the fourth side.

12. The cutting tool according to claim 10, wherein one of side surfaces of the peripheral side surface other than the constraint surface forms a flank whose clearance angle is negative with respect to a cutting edge provided on the first side.

13. The cutting tool according to claim 12, wherein the cutting insert adopts an axially symmetrical structure in which, when the cutting insert reversely rotates 180° about an X axis as a rotational center that is a perpendicular line passing a center of the center axis of the hole and extends along the second side and the fourth side, a side of the upper surface and a side of the lower surface have a same shape.

14. The cutting tool according to claim 13, wherein the cutting insert adopts a structure in which three sides of four sides on the upper surface side and three sides of four sides on the lower surface side can be used as cutting edges.

15. The cutting tool according to claim 14, wherein the cutting insert includes cutting edges provided to two adjacent corner parts of the corner parts.

16. The cutting tool according to claim 15, wherein the center axis of the hole is perpendicular to the upper surface and the lower surface.

17. The cutting tool according to claim 1, wherein, as the insert mounting part, two insert mounting parts on which the cutting inserts of a same shape are mounted at different postures, and that have mutually different orientations are provided.

18. The cutting tool according to claim 17, wherein the two insert mounting parts include a first insert mounting part on which the cutting insert is mounted at such a posture that long sides of four sides of the upper intersecting edge or the lower intersecting edge of the cutting insert are directed to a radial direction of the tool body, and a second insert mounting part on which the cutting insert is mounted at such a posture that the long sides are directed to a rotational axis direction of the tool body.

19. A cutting tool comprising a tool body that includes an insert mounting part for mounting a cutting insert including an upper surface, a lower surface, a peripheral side surface, a cutting edge, and a hole for a screw, the peripheral side surface including curved corner parts, the cutting edge being formed at a part of an upper intersecting edge of the upper surface and the peripheral side surface, and a lower intersecting edge of the lower surface and the peripheral side surface, and the hole penetrating the upper surface to the lower surface,
wherein the insert mounting part has a shape including
a bottom surface that includes a female screw part for a fixing screw inserted in the hole, and comes into contact with at least a part of the upper surface or the lower surface of the cutting insert,
a constraint surface that is a surface including a portion that comes into contact with at least a part of a constraint target surface formed as a surface of the peripheral side surface of the cutting insert inclining with respect to the upper surface or the lower surface, and whose inclination angle with respect to the bottom surface is an acute angle,
a relief part that is formed at a part that the corner parts of the cutting insert approach so as to hedge the corner parts, and
a protrusion area that extends from an upper side of the relief part so as to cover a part of the upper surface or the lower surface of the cutting insert mounted on the insert mounting part.

20. A tool body constituting the cutting tool according to claim 1.
